(19) United States
(12) Patent Application Publication
(10) Pub. No.: US 2008/0231072 A1
(43) Pub. Date: Sep. 25, 2008

(54) Vehicle Roof of a Convertible with Displaceable Rear Window

(76) Inventors: Massimo Franco, Collegno (IT); Pasquale Marrocco, Rivalta (IT)

Correspondence Address: DICKINSON WRIGHT PLLC, 1901 L. STREET NW, SUITE 800, WASHINGTON, DC, 20036, US

(21) Appl. No.: 12/093,529

(22) PCT Filed: Nov. 17, 2006
(86) PCT No.: PCT/DE2006/002039

§ 371 Date: May 13, 2008

(30) Foreign Application Priority Data
Nov. 17, 2005 (DE) 10 2005 055 383.4

(51) Int. Cl. B60J 7/00

(52) U.S. Cl. 296/108

(57) ABSTRACT

The invention relates to a vehicle roof of a convertible having a front roof part (2) and a rear roof part (3) that contains the rear window (14) and is hingedly connected to the vehicle body. Front and rear roof part are connected to one another in an articulated manner and can be displaced between a closed position over the vehicle interior and a rear put-away position. The rear window (14) which is pivotably mounted to the rear roof part (3) is connected at the front edge thereof to the front roof part by means of a control rod (22) of a control cinematics, which is pivotably mounted to the front roof part, while in the put-away position the rear window has a position which is elevated in relation to the rear roof part (3). According to the invention, a pivotable bearing part (20) of the control cinematics, which is mounted on the front side of the rear window (14), can be accommodated at the guide (21) of the control rod (22) so as to be displaceable.

The invention relates to a vehicle roof of a convertible, with a front roof part and a rear roof part which contains a rear window and is coupled to the vehicle body, the roof parts being connected to each other in an articulated manner and being displaceable between a closed position over the vehicle interior and a put-away position at the rear, wherein the rear window, which is mounted pivotably on the rear roof part, is connected at its front edge to the front roof part by means of a control link of a control kinematics, which control link is mounted pivotably on the front roof part, and, in the put-away position, said rear window takes up a position in which it is raised in relation to the rear roof part.

DE 199 36 252 C2 has disclosed a vehicle roof in which, during the putting away of the roof, the rear window is displaced continuously in relation to the rear roof part by means of a kinematic positive control means. The kinematic positive control means is produced via a displacement mechanism which has, for example, a four-bar linkage and a control lever which is connected thereto and acts on a lateral central section of the rear window. By means of said control lever, when the roof is closed, the rear window is held in its closed position on the rear roof part and, when the roof is put away, is held in a manner raised in relation to the rear roof part.

U.S. Pat. No. 6,866,324 B2 has disclosed a vehicle roof which, according to a first exemplary embodiment, is formed in a manner corresponding to that in DE 199 36 252 C2 mentioned above and pivots the rear window relative to the C pillars by means of a control lever which connects the front link of the four-bar linkage, which supports the roof, to the rear window. According to a second exemplary embodiment of the vehicle roof, a respective link is coupled pivotably in respective joints firstly to the front edge of the rear window and secondly to the rear edge of the roof shell of the front roof part. The link controls the relative movement of the front edge of the rear window in relation to the lateral C pillars and, when the roof is put away, raises the front edge of the rear window in relation to the lateral C pillars.

DE 198 07 490 C1 discloses a convertible hard top vehicle roof with a front roof part and a rear roof part, which roof parts can be pivoted about a vehicle-mounted main axis of rotation in order to put away the roof into a put-away space at the rear. A rear window is mounted on the rear roof part in a manner such that it can pivot in relation to the lateral C pillars of the rear roof part about a pivot bearing axis on the lower edge side. A dragging lever is coupled firstly to a coupling point in the rear region of the rear window and secondly to a joint mounted on the vehicle body in such a manner that, when the rear roof part is put away, the rear window is pivoted in relation to the lateral C pillars by means of the dragging lever into a raised put-away position.

In the case of the vehicle roof known from DE 199 32 503 A1, the rear window, which is mounted pivotably on the rear roof part, can be pivoted by means of its own drive in relation to the rear roof part.

The invention is based on the object of providing a vehicle roof mentioned at the beginning, in which the connection of the rear window to the front roof part and the control of its movement are improved.

According to the invention, the object is achieved in the case of the abovementioned vehicle roof in that a pivot bearing part of the control kinematics, said pivot bearing part being mounted on the front side of the rear window, is held displaceably on a guide of the control link. The displaceable mounting of the pivot bearing part on the control link enables execution of compensating movements which permit an improved movement behavior of the control kinematics and of the rear window as the roof is being put away.

Advantageous refinements of the invention are indicated in the subclaims.

The rear roof part preferably contains lateral C pillars, and the rear window is mounted in a manner such that it can pivot relative to the C pillars about a pivot axis arranged at its rear edge. Each of the two C pillars is then attached to a rear link of a four-bar linkage supporting the roof in a movable manner.

A stop for limiting the pivoting travel of the control link is expediently provided such that, in particular when the roof is closed, the rear window is arranged in a defined closed position via the control link bearing against the stop.

For an improved movement behavior, it can be provided that the pivot bearing part, which is formed, for example, as a bolt which is attached to the rear window or to a frame of the rear window, is guided displaceably on the guide between an inner position, which is adjacent to the pivot axis of the control link, and an outer position.

According to a preferred design, when the roof is closed and in a first pivoted position of the control link, the pivot bearing part is arranged in the outer position by means of a control part.

If, when the roof is opened, the pivot bearing part changes its pivoted position relative to the control link and, in the process, the control part takes up an inactive position, the pivot bearing part can execute a compensating movement along the guide of the control link.

A support is preferably provided on the vehicle body, said support supporting the rear window during the opening of the roof before the put-away position of the rear roof part and of the C pillars is reached. Then, over the course of the final movement during the opening of the roof, the rear window, which rests on the support, uses the pivot bearing part to pivot the pivoted-out control link back into its first pivoted position against the stop while the rear roof part and the C pillars drop into their put-away position relative to the rear window. The rear window is therefore secured in its put-away position in a defined manner.

Finally, over the course of the final movement during the opening of the roof, the pivot bearing part can execute a longitudinal movement on the guide into the outer position.

According to a preferred design, the control part is formed as a control cam which is connected in a rotationally fixed manner to the pivot bearing part and is supported on a supporting surface formed on the control link.

If, owing to the design of the control and bearing mechanism, during the putting away of the roof, the rear window executes a relative movement in relation to the support, it is advantageous if the at least one support contains a roller on which the rear window rests. The roller permits a simple compensating movement, and therefore the rear window does not have to slide on a fixed support.

A respective support preferably supports the rear window on its opposite side edges, in particular in the vicinity of its upper edge. The region below the rear window therefore remains unobstructed for loading purposes.

The roof is, in particular, a hard top roof of a vehicle, but it may also be formed as a soft top or have soft top elements.

The vehicle roof is explained in more detail below using an exemplary embodiment and with reference to the drawing, in which:

FIG. 1 shows, in a lateral top view, a vehicle roof with a front roof part and a rear roof part in a closed position above a vehicle interior;

FIG. 2 shows, in a view according to FIG. 1, the vehicle roof in a first intermediate position during the opening operation;

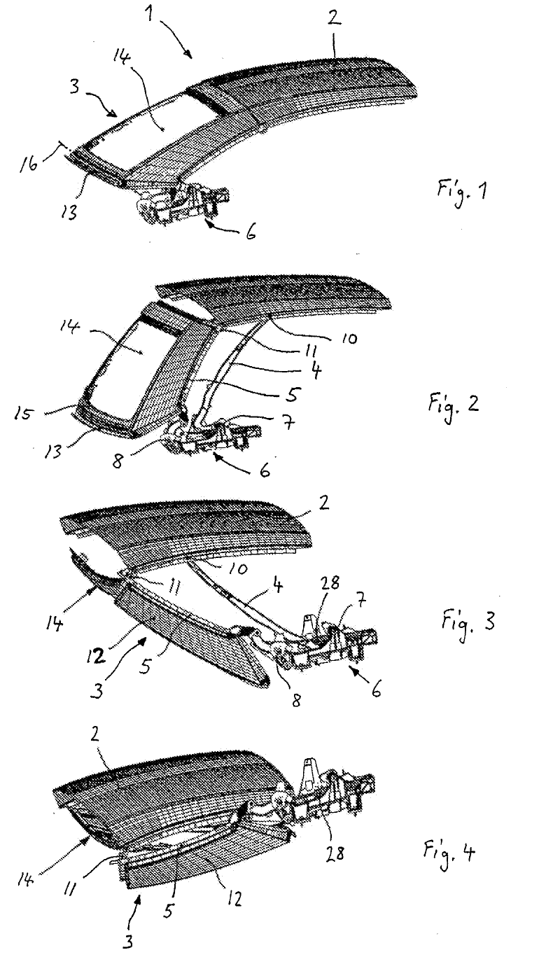

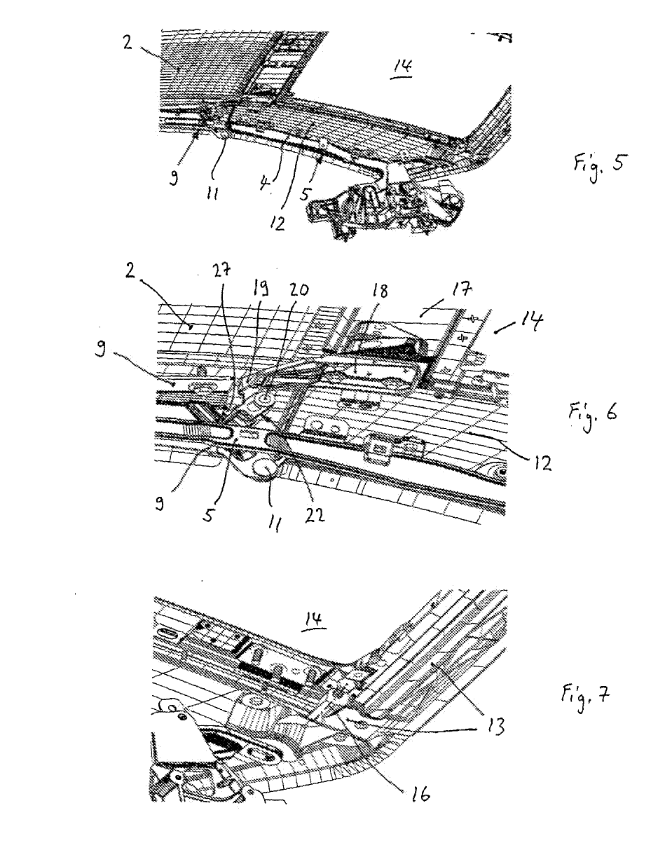

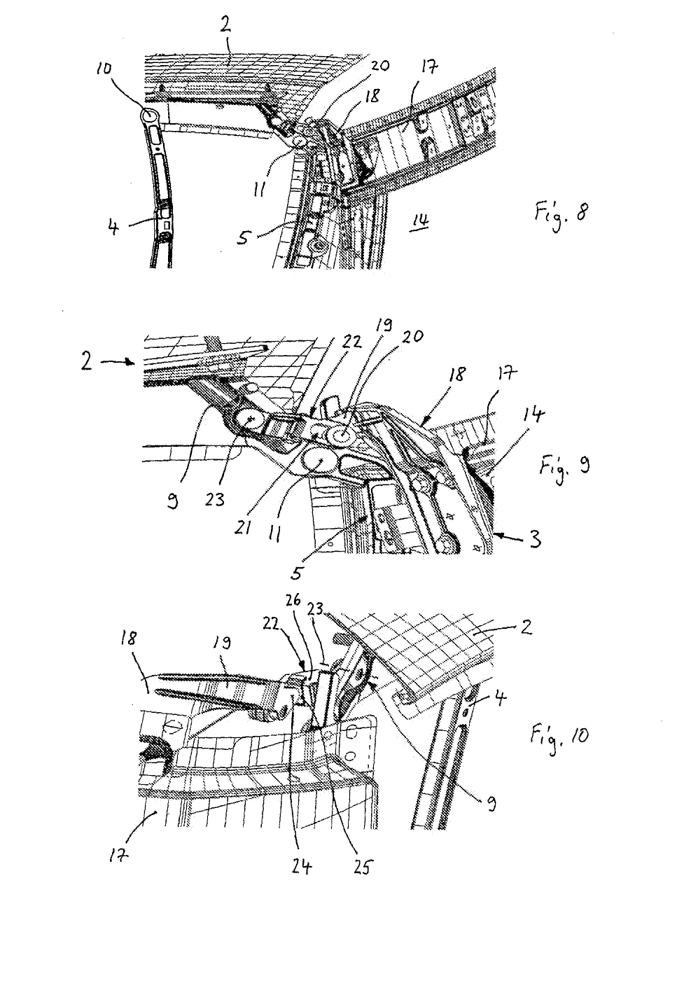

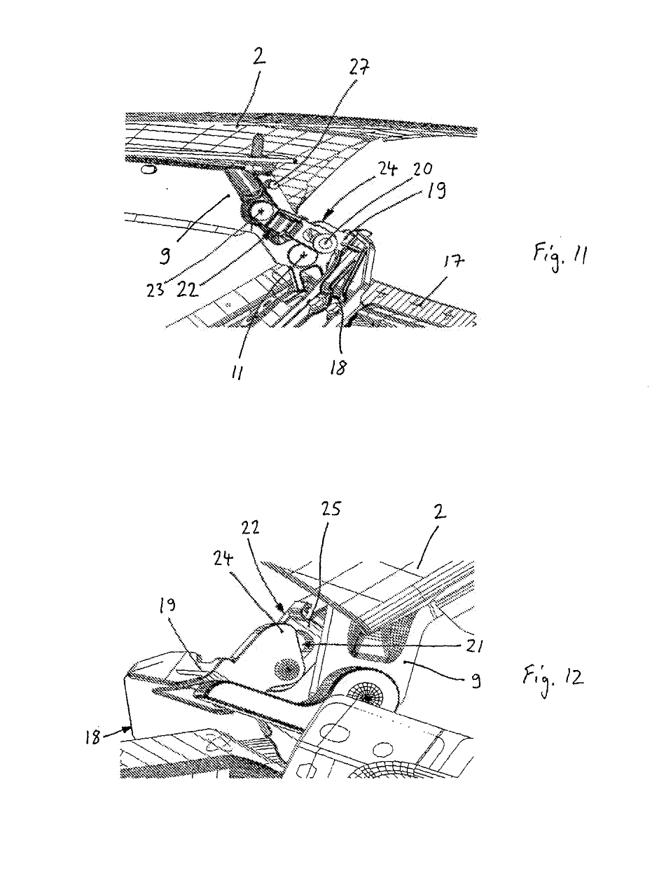

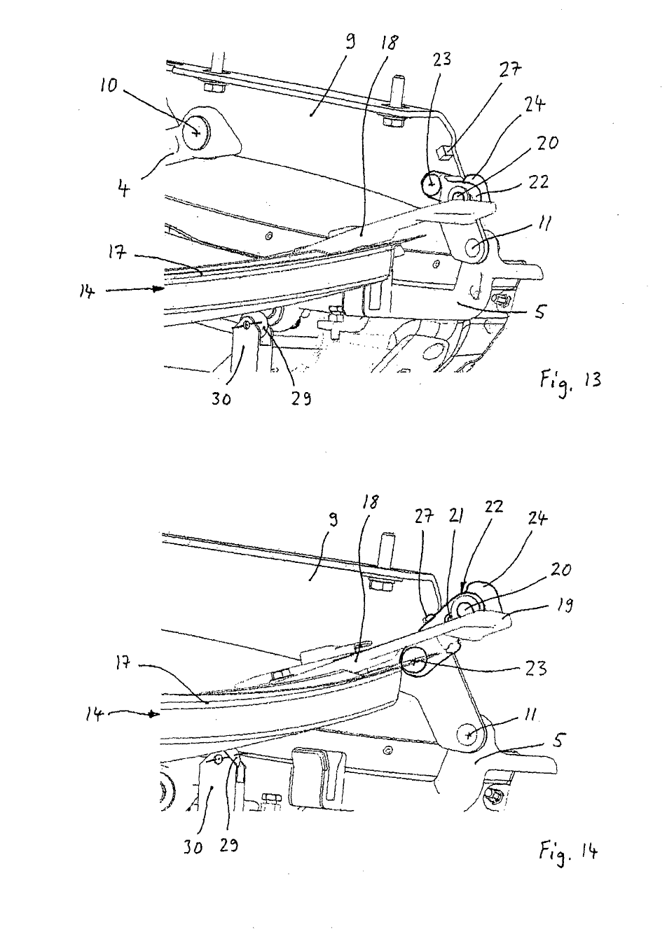

FIG. 3 shows, in a view according to FIG. 1, the vehicle roof in a second intermediate position during the opening operation;

FIG. 4 shows, in a view according to FIG. 1, the vehicle roof in an open put-away position;

FIG. 5 shows, in an inside view, the right side of the closed roof;

FIG. 6 shows, in an inside view according to FIG. 5 in an enlarged illustration, a control kinematics of a rear window mounted displaceably on the rear roof part;

FIG. 7 shows, in an inside view, the rear roof part, which is closed according to FIG. 5, together with a pivot mounting of the rear window;

FIG. 8 shows, in a view according to FIG. 5, the roof in an intermediate position during the opening operation;

FIG. 9 shows, in an inside view according to FIG. 8 in an enlarged illustration, the control kinematics of the roof arranged in the intermediate position;

FIG. 10 shows, in a top view, the control kinematics in the position according to FIG. 8;

FIG. 11 shows, in an inside view according to FIG. 9, the control kinematics of the roof arranged in a further intermediate position;

FIG. 12 shows, in a top view, the control kinematics in the position according to FIG. 11;

FIG. 13 shows, in a top view of the lateral inside of the roof, the control kinematics in an intermediate position of the roof, with the rear window resting on a support on the vehicle body;

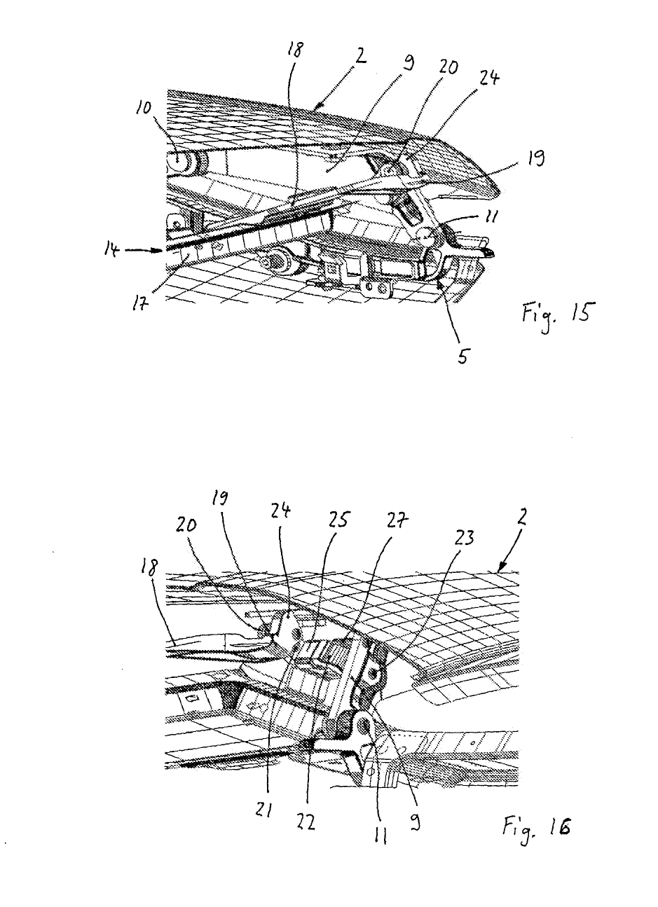

FIG. 14 shows, in a view according to FIG. 13, the control kinematics when the roof is put away fully and the rear window raised to the maximum extent;

FIG. 15 shows, in a top view of the lateral inside of the roof, the control kinematics when the roof is put away completely and the rear window is raised to the maximum extent; and

FIG. 16 shows, in an exterior view, the control kinematics when the roof is put away completely and the rear window is raised to the maximum extent.

A hard top roof 1 of a vehicle contains a front roof part 2 and a rear roof part 3, which roof parts can be displaced between a closed position (FIG. 1) over the vehicle interior and an open position (FIG. 4) in which they are put away in a put-away space or folding-top compartment at the rear. A roof of this type is basically known from DE 199 36 252 C2 or U.S. Pat. No. 6,866,324 B2. The roof 1 is essentially constructed symmetrically with respect to the longitudinal axis of the vehicle with identical bearing and driving devices on both sides, and therefore the roof 1 is described essentially with reference to the bearing and driving devices of one side.

The roof 1 is mounted movably on the vehicle body by means of a bearing device in the form, for example, of a four-bar linkage which has a front link 4 and a rear link 5, which links, firstly, are mounted on a main bearing 6 mounted on the vehicle body in a manner such that they can pivot in pivot axes 7 and 8 and, secondly, are coupled to a support part 9 in a manner such that they can pivot in pivot axes 10 and 11. The in particular hard-shell front roof part 2 is fastened to the support part 9.

The rear roof part 3 laterally contains a respective C pillar 12 attached to the rear link 5. The two opposite C pillars 12 are connected directly to each other only at their lower edge by means of a transverse part 13, for example a frame which can also be fastened to the respective rear link 5. A rear window 14 is arranged in the opening between the two C pillars 12, said rear window being mounted at its lower or rear edge 15 on the transverse part 13 in a manner such that it can pivot about a pivot axis 16 and in relation to the two C pillars 12. At least at its upper edge, the rear window 14 contains a window frame 17 to which a respective mount 18 is laterally fastened by a forwardly projecting arm 19 to which a laterally protruding bearing bolt 20 is attached, the bearing bolt being part of a control kinematics for controlling the movement of the rear window 14 relative to the C pillars 12. The bearing bolt 20 is held displaceably in an elongated hole 21 which is formed on a control link 22 which is mounted on the support part 9 of the front roof part 2 in a manner such that it can pivot about a pivot axis 23.

The front end of the arm 19 of the mounting 18 contains a control cam 24 (see in particular FIGS. 10 and 12) which protrudes beyond the axis of the bearing bolt 20 and is arranged on the arm 19 in such a manner that it can come, as a function of the position of the mounting 18, into supporting engagement with the control link 22 on a supporting surface 25, which is formed on a shoulder 26 of the control link 22, and can therefore determine the position of the bearing bolt 20 in the elongated hole 21.

When the roof 1 is closed (see FIGS. 1, 5 and 6), the control kinematics keeps the rear window 14 in its closed position flush with the lateral C pillars 12 and with the front roof part 2. In this position, that arm 19 of the mounting 18 which belongs to the control kinematics extends forward under the roof part 2 and, by means of the bearing bolt 20, keeps the control link 22 in an upper pivoted position in which it bears against a stop 27 arranged fixedly on the support part 9. In this position of the arm 19 with respect to the control link 22, the control cam 24 projects with its maximum lift with respect to the axis of the bearing bolt 20 against the supporting surface 25 and, owing to its control contact with the supporting surface 25, keeps the bearing bolt 20 in the elongated hole 21 in the first outer end position in which it is located at a maximum distance from the pivot axis 23 of the control link 22.

In order to open the roof, a respective lateral hydraulic cylinder 28 arranged on the main bearing 6 is actuated and extended and, via an intermediate mechanism, pivots the rear link 5 and therefore the rear roof part 3 to the rear (FIG. 2). Owing to the four-bar-linkage arrangement of the links 4 and 5, the front roof part 2 pivots about the pivot axis 11 toward the rear roof part 3, and the arm 19 of the mounting 18, which is connected to the rear window 14, pivots the control link 22 downward about its axis 23 such that first of all their relative position with respect to each other is maintained and the control cam 24 remains with its maximum cam height in contact with the supporting surface 25. In this case, owing to the kinematics illustrated, the mounting 18 pulls the front window frame 17 of the rear window 14 towards the pivot axis 11 (FIGS. 8 to 10) and pivots said rear window about its lower pivot axis 16 inward or toward its inner side relative to the C pillars 12 of the rear roof part 3.

During further opening of the roof (see FIGS. 3 and 11 and 12), the rear roof part 3 reaches a position in which it is largely pivoted over, and the front roof part 2 is lowered toward the inside of the rear roof part 3. The arm 19 of the mounting 18 has been pivoted further relative to the control link 22 such that the control cam 24 has been disengaged from the supporting surface 25 and has moved away from the latter. The bearing bolt 20 can therefore execute a longitudinal compensating movement in the elongated hole 21. The weight of the rear window 14 continues to keep the bearing bolt 20, for example, in its outer position, in the elongated hole 21 of the control link 22. The control link 22 continues to keep the rear window 14 raised or pivoted inward in relation to the two C pillars 12 via the bearing bolt 20 and the arm 19.

Shortly before the put-away position of the roof 2 is reached, the rear window is placed on a support 29 on the vehicle body, for example on a respective lateral supporting roller which is mounted on a mounting 30 and supports the rear window 14, in particular on its side edge, in the vicinity of the upper edge (FIG. 13). The bearing bolt 20 takes up a position in which it is shifted inward in the direction of the pivot axis 23 of the control link 22.

As the roof 2 continues to be put away, the C pillars 12 move downward into their final put-away position while, via the supported rear window 14 and the arm 19, the bearing bolt 20 executes a compensating movement in the elongated hole 21 in the direction of the outer position and at the same time pivots the control link 22 upward again against the stop 27 (see FIGS. 14 to 16).

In the put-away end position of the roof 2 (see FIGS. 4 and 14 to 16), the rear window 14, which is pivoted upward to the maximum extent about its pivot axis 17 in relation to the lateral C pillars 12, therefore rests in the region of its upper edge on the support 29 and is upwardly supported on the stop 27 via the control link 22 in a play-free manner.

The support 29 is expediently formed, for example, as a plastic or rubber roller, and therefore the rear window 14 can execute a compensating movement on the roller as it is being put away.

The closing of the put-away roof 2 takes place in an opposite sequence of movement. By means of the respective hydraulic cylinder 28, the rear link 5 is pivoted upward, with the C pillars 12 of the rear roof part 3 being raised and, owing to its weight, the rear window 14 initially still remaining on the respective support 29 or roller. The bearing bolt 20 moves in the elongated hole 21 of the control link 22 and, by means of the pivoting of the arm 19 relative to the control link 22, the control cam 24 comes into engagement again with the supporting surface 25. By means of the relative movement of the C pillars 12 with respect to the front roof part 2 or the support part 9 thereof, the arm 19 pivots in relation to the control link 22 into the starting position and the control cam 24 reaches its maximum lift position on the supporting surface 25 such that the bearing bolt 20 is again arranged in the outer position in the elongated hole 21.

Finally, the driving device or the hydraulic cylinder 28 pivots the roof 1 into the closed position which is shown in FIG. 1 and in which the front roof part 2 is kept locked to a cowl. However, this locking is not the subject matter of this application and therefore is neither described nor illustrated here.

### LIST OF REFERENCE NUMBERS

1 Hard top roof
2 Front roof part
3 Rear roof part
4 Front link
5 Rear link
6 Main bearing
7 Pivot axis
8 Pivot axis
9 Support part
10 Pivot axis
11 Pivot axis
12 C pillar
13 Transverse part
14 Rear window
15 Lower or rear edge
16 Pivot axis
17 Window frame
18 Mounting
19 Arm
20 Bearing bolt
21 Elongated hole
22 Control link
23 Pivot axis
24 Control cam
25 Supporting surface
26 Shoulder
27 Stop
28 Hydraulic cylinder
29 Support
30 Mounting

1. A vehicle roof of a convertible, with a front roof part and a rear roof part which contains a rear window and is coupled to the vehicle body, the roof parts being connected to each other in an articulated manner and being displaceable between a closed position over the vehicle interior and a put-away position at the rear, wherein the rear window, which is mounted pivotably on the rear roof part, is connected at its front edge to the front roof part by means of a control link of a control kinematics, which control link is mounted pivotably on the front roof part, and, in the put-away position, said rear window takes up a position in which it is raised in relation to the rear roof part, characterized in that a pivot bearing part of the control kinematics, said pivot bearing part being mounted on the front side of the rear window, is held displaceably on a guide of the control link.

2. The vehicle roof of claim 1, characterized in that the rear roof part has lateral C pillars, and in that the rear window is mounted in a manner such that it can pivot relative to the C pillars about a pivot axis arranged at its rear edge.

3. The vehicle roof of claim 1, characterized in that a stop for limiting the pivoting travel of the control link is provided.

4. The vehicle roof of claim 1, characterized in that the pivot bearing part is guided displaceably on the guide between an inner position, which is adjacent to the pivot axis of the control link, and an outer position.

5. The vehicle roof of claim 1, characterized in that, when the roof is closed and in a first pivoted position of the control link, the pivot bearing part X is arranged in the outer position by means of a control part.

6. The vehicle roof of claim 1, characterized in that, when the roof is opened, the pivot bearing part changes its pivoted position relative to the control link and, in the process, the control part takes up an inactive position such that the pivot bearing part can execute a compensating movement along the guide of the control link.

7. The vehicle roof of claim 1, characterized in that a support is provided on the vehicle body, said support supporting the rear window during the opening of the roof before the put-away position of the rear roof part and of the C pillars is reached.

8. The vehicle roof of claim 1, characterized in that, over the course of the final movement during the opening of the roof, the rear window, which rests on the support, uses the pivot bearing part to pivot the pivoted-out control link back into its first pivoted position against the stop while the rear roof part and the C pillars drop into their put-away position relative to the rear window.

9. The vehicle roof of claim 8, characterized in that, over the course of the final movement during the opening of the roof, the pivot bearing part executes a longitudinal movement on the guide into the outer position.

10. The vehicle roof of claims of claim 4, characterized in that the control part is formed as a control cam which is connected in a rotationally fixed manner to the pivot bearing part and is supported on a supporting surface formed on the control link.

11. The vehicle roof of claim 1, characterized in that, during the putting away of the roof, the rear window executes a relative movement in relation to the support.

12. The vehicle roof of claim 1, characterized in that the at least one support contains a roller on which the rear window rests.
